(19) United States
(12) Patent Application Publication
(10) Pub. No.: US 2017/0094027 A1
(43) Pub. Date: Mar. 30, 2017

(54) TARGETED FILE TRANSFER TRACKER PROCESS

(71) Applicant: MASTERCARD INTERNATIONAL INCORPORATED, PURCHASE, NY (US)

(72) Inventors: WEIHUA ZHOU, Chesterfield, MO (US); DOUGLAS PAUL FORGUSON, Richmond Heights, MO (US); UDAY KUMAR SURVI, Dardenne Prarie, MO (US)

(73) Assignee: MASTERCARD INTERNATIONAL INCORPORATED, PURCHASE, NY (US)

(21) Appl. No.: 14/866,249

(22) Filed: Sep. 25, 2015

(51) Int. Cl. H04L 29/08; H04L 12/24; H04L 12/26

(52) U.S. Cl. CPC H04L 67/36; H04L 67/06; H04L 43/16; H04L 41/064

(57) ABSTRACT

A file transfer monitoring system and method for monitoring the transfer of electronic files from a transfer source to a transfer target includes a tracking server and a data store, wherein the tracking server includes a prediction engine, a parameter database, and a monitoring component, the prediction engine is configured to receive one or more data transfer parameters from a parameter database and generate an expected data transfer time (EDT) as a function of the one or more data transfer parameters, and the monitoring component is configured to receive the EDT from the prediction engine, receive a transfer start signal from the transfer source, start a timer when the transfer start signal is received, and trigger an alert condition action if the a transfer complete signal is not received before the timer exceeds a threshold value relative to the EDT.

### TECHNICAL FIELD

The present disclosure is generally related to application architectures. More particularly, the present disclosure is directed to systems and methods for managing file transfer processes.

### BACKGROUND

The electronic transfer of files from a source location to a target location may be accomplished using file transfer protocols implemented over a data network. In some instances, file transfers may take longer than expected, or fail to complete, due to various issues on the data network, target location, or source location. For example, a loss or degradation of network connectivity may cause the file transfer to slow or stop altogether. In some file transfer architectures, files are transferred serially, such that a delay or data transfer stoppage will impact or stop subsequent file transfers.

Monitoring algorithms generally calculate expected file transfer times for monitoring purposes based on file sizes and available bandwidth between a source location and the first node on the data network. However, these file transfer monitoring algorithms do not account for data network complexities in the data network between the source and target locations, including the number of nodes, the time of day, geography, or other parameters that could affect data transfer. Accordingly, the calculation of file transfer times may not be precise, resulting in inefficient monitoring and automation of responses to file transfer failures or degradations.

### SUMMARY

The present disclosure is directed towards a file transfer monitoring system and method for monitoring the transfer of electronic files from a transfer source (e.g., a file transfer server) to a transfer target. Some embodiments of the system include a tracking server and a data store. The tracking server may include a prediction engine, a parameter database, and a monitoring component, wherein the prediction engine includes a computer processor and a non-transitory computer-readable medium having a computer-executable program embedded thereon, the computer-executable program being configured to receive one or more data transfer parameters from a parameter database and generate an expected data transfer time (EDT) as a function of the one or more data transfer parameters.

The monitoring component (i.e., also a computer-executable program embedded on non-transitory computer-readable media) is configured to receive the EDT from the prediction engine, receive a transfer start signal from the transfer source, start a timer when the transfer start signal is received, and trigger an alert condition action if the a transfer complete signal is not received before the timer exceeds a threshold value relative to the EDT. For example, the data transfer parameters may include a size of the electronic file, a historical average transfer rate between the transfer target and the transfer source, a server capacity value, a server load value, a network capacity value, a network load value, a type of the electronic file, or a transfer protocol. In some embodiments, the data transfer parameters also include a set of historical transfer rates between the transfer target and the transfer source, wherein each historical transfer rate is correlated with a time of day. In other embodiments, the data transfer parameters also include a set of historical transfer rates between the transfer target and the transfer source, wherein each historical transfer rate is correlated with a geographical location of the transfer source.

Some examples of the system also include a user interface that is configured to receive a pre-defined transfer duration parameter from a user input device. For example, the pre-defined transfer duration parameter may be the threshold value. In some embodiments, the alert condition action includes the transmission of an alert message to a user device or the transmission of a transfer termination signal to the transfer source.

This disclosure is also directed towards a computer implemented method of tracking a file transfer process. For example, the method may include receiving, with a prediction engine, one or more data transfer parameters and generating, with the prediction engine, an expected data transfer time (EDT) as a function of the data transfer parameters. The method may also include receiving, with a monitor component, the EDT and a transfer start signal, initiating a timer, and initiating an alert condition action if the timer exceeds a threshold value relative to the EDT.

In some embodiments, the method includes receiving a plurality of threshold values, and a transfer start signal, initiating a timer, and initiating a first alert condition action if the timer exceeds a first threshold value relative to the EDT. The method may also include initiating a second alert condition action if the timer exceeds a second threshold value relative to the EDT. For example, the first alert condition comprises transmitting an alert message to a user device and the second alert condition comprises transmitting a transfer termination signal to the transfer source.

This summary of example embodiments is not intended to be exhaustive or to limit the various embodiments to the precise form disclosed.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 illustrates an example payment card transaction processing system.

FIG. 2 illustrates an example of a system for predicting and tracking the transfer of files, consistent with embodiments disclosed herein.

FIG. 3 illustrates an example of a process for tracking the transfer of files, consistent with embodiments disclosed herein.

FIG. 4 is a flowchart illustrating and example file transfer tracker process, consistent with embodiments disclosed herein.

FIG. 5 illustrates an example computing component that may be used in implementing features of various embodiments of the present disclosure.

The drawings are described in greater detail in the description and examples below. The drawings are not intended to be exhaustive or to limit the various embodiments to the precise form disclosed. It should be understood that embodiments can be practiced with modification and alteration.

### DETAILED DESCRIPTION

The details of some example embodiments of the methods and systems of the present disclosure are set forth in the description below. Other features, objects, and advantages of the disclosure will be apparent upon examination of the following description, drawings, examples and claims. It is intended that all such additional systems, methods, features, and advantages be included within this description, be within the scope of the present disclosure, and be protected by the accompanying claims.

In the context of payment transaction processing, large numbers and/or batches of files and data (e.g., money files, rewards files, settlement clearing data, etc.) may be transferred between the payment network and its customers (e.g., to and from banks, merchants, etc.) as will be described in greater detail below. In order to effectuate the transfer of these files, an entity such as the payment network itself may customize web applications or create proprietary frameworks/software such as secure transport managed file transfer software. Given this reliance upon the transfer of files, monitoring and responding to data network issues, delays, or degradation in an efficient, and in many cases, automated manner is prudent.

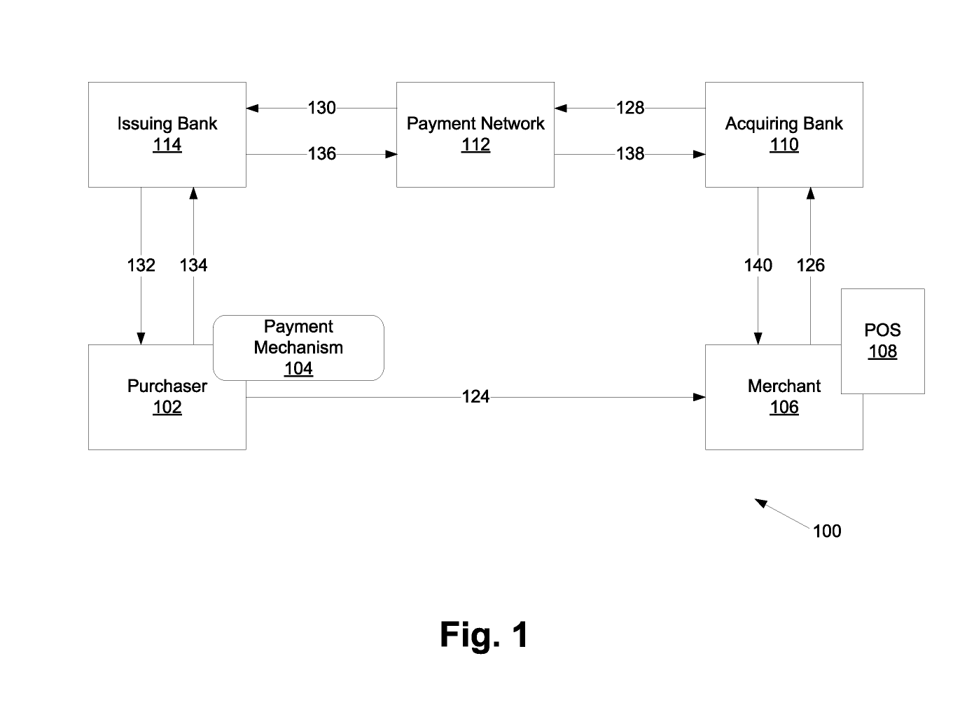

As instances of the present disclosure relate to electronic transaction processing and data generated and collected thereby, the following description provides relevant context for various embodiments described herein. For example, FIG. 1 depicts example payment card transaction processing system 100, which may operate in connection with embodiments of the disclosed systems, methods, and devices. Transaction processing of card-based payments, including electronic payments, may include both an authorization side and a clearing side. System 100 depicts both the authorization side and the clearing side of card-based payment transactions.

The authorization side may involve the process of confirming that a cardholder (or purchaser) has a sufficient line of credit to cover a proposed payment for an item. The clearing side of the transaction may involve reconciliation between an issuing bank (of a payment card) 114 and an acquiring (or merchant) bank 110—e.g., determining the amount owed by issuing bank 114 to acquiring bank 110 or vice versa. Later on, funds may be exchanged between issuing bank 114 and acquiring/merchant bank 110, typically based on the clearing process.

In a typical card-based payment system transaction (or purchase transaction), purchaser 102 presents payment mechanism 104, which in various embodiments is a credit/debit/prepaid card, to merchant 106 for the purchase of an item. This purchase transaction is indicated by arrow 124. The item may be a good and/or a service. “Payment mechanism” 104 or “payment card,” as used herein, may also refer to a conventional magnetic-stripe credit or debit card, or similar proximity payment device (utilized on its own or incorporated into another device such as a mobile telephone, personal digital assistant (PDA), etc.) having near field communications (NFC) capabilities, such as a radio frequency identification (RFID) chip implemented therein. “Payment mechanism” 104 or “payment card” may also further refer to virtual or limited-use account numbers and electronic wallets and the like, such as may be used in online transactions.

It will be understood by those of ordinary skill in the art that, prior to the occurrence of such a transaction, purchaser 102 was issued payment mechanism 104 by issuing bank 114. Each payment mechanism 104 is typically associated with an account of purchaser 102, whether purchaser 102 is an individual or some other entity. Likewise, each transaction entered into using payment mechanism 104 is associated with the account. In this regard, for each purchase transaction, payment network 112 processes account transactions by associating each transaction with the corresponding account, as is described in detail below. Periodically, as payment network 112 collects and processes account transactions, the information associated with these transactions is stored and sorted so that it may be subsequently analyzed, dispersed, and the like, as desired.

Moreover, it will be understood that merchant 106 has established a relationship with acquiring bank 110, thereby allowing merchant 106 to receive payment mechanism 104 (e.g., credit/debit cards) as payment for items. That is, acquiring/merchant banks (e.g., 110) and issuing banks (e.g., 114) may participate in various payment networks, including, by way of example, payment network 112. One such payment network is operated by MasterCard International Incorporated, the assignee of the present disclosure.

Referring again to FIG. 1, after purchaser 102 presents payment mechanism 104 to merchant 106, merchant 106 may send a request message (indicated by arrow 126), which in some embodiments may be all or part of an authorization request, to acquiring bank 110 via point-of sale (POS) terminal 108 located at or otherwise controlled by merchant 106. In turn, acquiring bank 110 communicates with payment network 112 (indicated by arrow 128), and payment network 112 communicates with issuing bank 114 (indicated by arrow 130) to determine whether purchaser 102 is authorized to make transaction 124. Issuing bank 114 either approves or declines the authorization request and thereafter transmits a response back to merchant 106 (indicated by arrows 136, 138, and 140). Merchant 106 may then either complete or cancel purchase transaction 124, based upon the response to the request message.

If purchase transaction 124 is approved, the transaction amount associated therewith will be sent from issuing bank 114 through payment network 112 to acquiring bank 110. The transaction amount, minus certain fees, will thereafter be deposited within a bank account belonging to merchant 106, in accordance with a process called settlement. Issuing bank 114 thereafter bills purchaser 102 (indicated by arrow 132) for all purchase transactions conducted over a given period of time by sending a statement to purchaser 102. Purchaser 102 responds by submission of payment(s) (as indicated by arrow 134) to issuing bank 114. This submission of payment(s) (as indicated by arrow 134) by purchaser 102 may be automated (e.g., in the case of debit transactions), may be initiated by purchaser 102 for the exact amount matching amounts of purchases during the statement period (e.g., charge cards or credit balances paid in full), and/or may be submitted (in part or in whole) over a period of time that thereby reflects the amount of the purchases, plus any financing charges agreed upon beforehand between purchaser 102 and issuing bank 114 (e.g., revolving credit balances).

Payment network 112 may include at least one of each of the following: storage, servers, and mainframes (none of which are shown in FIG. 1, but each of which will be appreciated by one of skill in the art upon studying the present disclosure). The mainframes may include a processing device and may be configured to implement the authorization and clearing process, with such configuration and/or associated instructions being stored in the storage and through various network connections to respective counterpart computer systems at issuing bank 114 and acquiring bank 110. The storage may include computer-readable-media storage technologies, such as a floppy drive, hard drive, tape drive, flash drive, optical drive, read-only memory (ROM), random access memory (RAM), and/or the like. The servers and the storage may be controlled by software/hardware and may store data and/or instructions to allow the mainframes to operate in accordance with aspects of the present disclosure. POS terminal 108 is in data communication, directly or indirectly, and at least from time to time, with, e.g., an acquirer host computer (not shown) that is part of payment network 112, and that is operated by or on behalf of acquiring bank 110, which handles payment card transactions for merchant 106. The server may be operated by or on behalf of the payment network 112, and may provide central switching and message routing functions among the member financial institutions of payment network 112. Issuing bank 114 also may make use of an issuer host computer (not shown), and an access point (not shown), via which the issuer host computer exchanges data messages with the server.

It should be noted that, in practice, payment card transaction processing system 100 may involve a number of cardholders/purchasers 102, POS terminals 108, merchants 106, acquirer host computers, issuer host computers, and access points, as well as a number of respective acquiring and issuing banks 110 and 114. In general, the acquirer host computer may receive authorization requests from POS terminals 108, forward the authorization requests through payment network 112, receive authorization responses, and relay the authorization responses back to POS terminal 108. Moreover, the issuer host computer may, in general, receive authorization requests from the servers and transmit authorization responses back to the server based on the authorization requests.

Also included in a typical card-based payment system transaction are the clearing and settlement processes described above. Clearing (which may happen after transmission of the authorization response if approved) may refer to a process by which issuing bank 114 exchanges transaction information with acquiring bank 110 (also referred to as merchant bank). Referring again to FIG. 1, acquiring bank 110 may transmit transaction information to payment network 112, which may include a clearing system (not shown in FIG. 1). The clearing system may validate the transaction information and forward it to issuing bank 114, which prepares data to be included on a payment statement for purchaser 102. The clearing system 114 may then provide reconciliation data to both issuing bank 114 and acquiring bank 110.

Settlement may refer to a process by which issuing bank 114 exchanges the requisite funds with acquiring bank 110 to complete an approved transaction. In particular, acquiring bank 110 may send clearing data in a clearing message to payment network 112, whereupon payment network 112 calculates a net settlement position and sends advisement to acquiring bank 110 and issuing bank 114. Issuing bank 114 may remit payment to payment network 112, which then sends the payment to acquiring bank 110. Acquiring bank 110 then pays merchant 106 for the purchase made by purchaser 102, and issuing bank 114 bills purchaser 102.

Having provided this context for payment card transaction processing system 100, specific embodiments of the present disclosure will now be described. One of skill in the art will recognize, upon studying the present disclosure, that system 100 merely represents one way in which large data sets are generated, processed, and/or transferred, and that system 100 may be modified to represent other environments in which such data sets are generated, such as in the medical records, retail, government, and other contexts. Such modifications are within the scope of the present disclosure. Further, as will be understood by one of skill in the art, the above-described processing of transactions typically involves a significant amount of data being generated, stored, and transferred, for example using payment network 112. In this regard, payment card transaction processing systems, such as system 100, typically utilize database capabilities within or in conjunction with payment network 112 to store, sort, and analyze transaction data associated with the transactions processed through system 100.

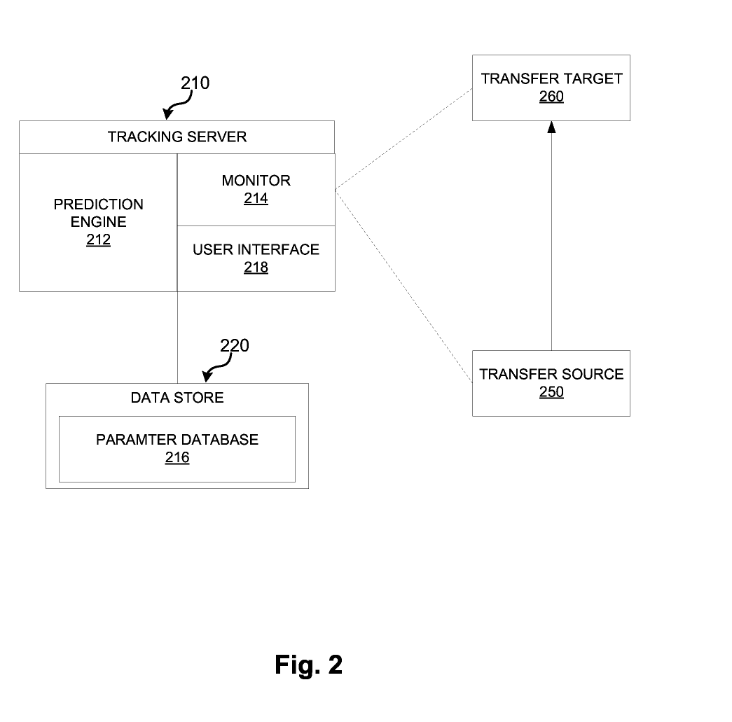

FIG. 2 illustrates an example of a system for predicting and tracking the transfer of files. Referring to FIG. 2, the system includes a tracking server 210 and a data store 220. Tracking server 210 may include a prediction engine 212 and a parameter database 216. In some embodiments, prediction engine 212 may include or share a portion of a computer processor and non-transitory computer readable media with software embedded thereon, the software configured to execute a file transfer prediction process. For example, to predict an expected data transfer time (EDT) for transferring a file from a transfer source 250 to a transfer target 260, prediction engine 212 may receive data transfer parameters pᵢ from parameter database 216, residing on data store 220, relating to characteristics of transfer source 250, transfer target 260, and historical file transfer data describing previous file transfers from transfer source 250 to transfer target 260. For example, the transfer source 250 and transfer target 260 may each be a computer, such as a file server, mainframe, application server, desktop computer, laptop, tablet, handheld computer, or other computing device with the capability of storing electronic data and transmitting or receiving the electronic data using file transfer protocols as described herein. Prediction engine 212 may then generate an expected transfer time as a function of the data transfer parameters, as per Equation 1.

EDT=f(pᵢ) (1)

Data transfer parameters p,, stored in parameter database 216, may include one or more of the following: length of time for completion of one or more previous file transfers between transfer source 250 and transfer target 260; historical transfer rate(s) for previous file transfers (i.e., the file size divided by the length of time for the file transfer to complete); geographical locations of either or both of transfer source 250 and transfer target 260; time of day; date; historical transfer rate between transfer source 250 and transfer target 260 correlated with the time of day or date; size of the file being transferred; server capacity; server load; network capacity; network load; file type; file transfer protocol being used (i.e., FTP, sFTP, HTTP, HTTPS, SMTP, etc.); user defined parameters; or other parameters that may affect the rate at which data may transfer between transfer source 250 and transfer target 260 as known in the art.

Tracking server 210 may also include monitor component 214 configured to monitor the start time, progress, and completion time of a file transfer between transfer source 250 and transfer target 260. In some embodiments, monitor component 214 may include or share a portion of a computer processor and non-transitory computer readable media with software embedded thereon, the software configured to execute a file transfer tracker process. For example, monitor component 214 may receive a transfer start signal from transfer source 250 indicating that the file transfer started. The transfer start signal may be transmitted to tracking server 210 from transfer source 250 using internet protocols (IP) such as TCP/IP, UDP/IP, SNMP, or other communication protocols as known in the art. Monitor component 214 may also receive an EDT from prediction engine 212, start a timer to track active transfer time (ATT) and compare the ATT with the EDT. Monitor component 214 may stop the timer tracking the ATT if and when a transfer complete signal is received from transfer source 250 or transfer target 260. The transfer complete signal may be transmitted from either transfer source 250 or transfer target 260 to monitor component 214 using the same communication protocols as are used to transmit the transfer start signal. In some examples, monitor component 214 may query either the transfer source 250 or the transfer target 260 for the transfer complete signal, or for information indicating that the transfer source 250 and transfer target 260 are still alive and responsive (i.e., the transfer process is still active). If no transfer complete signal is received by monitor component 214, and the ATT exceeds the EDT threshold, monitor component 214 may output an alert signal indicating that the file transfer has exceeded a threshold transfer time.

Tracking server 210 may also include a user interface component 218. In some embodiments, user interface component 218 may include or share a portion of a computer processor and non-transitory computer readable media with software embedded thereon, the software configured to execute a user interface process, and to send information to a display, and accept input from a user input device. For example, the user interface component 218 may be configured to display information, such as transfer parameters and corresponding values, EDT, ATT, current transfer status, alert signals, alert condition automation preferences (i.e., desired actions that may be implemented by tracking server 210 should the ATT exceed the EDT), as well as a prompt for users to enter additional user-defined transfer parameters, threshold information, or other settings and preferences as known in the art. User interface component 218 may also be configured to accept user input from a standard input device such as a touch screen, microphone and voice recognition device, keyboard, mouse, or other input device as known in the art. Additional user-defined parameters may include a manually-entered expected transfer rate, a maximum threshold value for the EDT, a threshold value as a percentage of the EDT, or other user-defined parameters.

The alert condition automation preferences may include setting a threshold value at which an alert is issued relative to the difference between the ATT and the EDT. The alert setting may enable the monitor component 214 to send an alert message to the user interface component 218 to warn a user that the threshold value has been exceeded. In some examples, the alert setting may also enable the monitor component 214 to send a file transfer termination signal to transfer source 250 to terminate the transfer of the file. The file transfer termination signal may cause the transfer source 250 to kill the file transfer process or thread responsible for the transfer of a single file, or alternatively, may kill or restart the file transfer service or daemon completely. In some examples, the monitor component 214 may also send an output signal to a load balancing component (not shown) to cause the file transfer to reinitiate down an alternate network connectivity path, or from an alternate transfer source altogether.

In some examples, the alert setting may also enable the monitor component 214 to send an alert message to a user device (not shown) using network transmission protocols such as SNMP, SMS, SMTP, HTTP, or other similar protocols as known in the art. For example, the user device may be a desktop computer, a laptop computer, a tablet computer, a mobile phone, a pager, or other devices capable of receiving electronic messages.

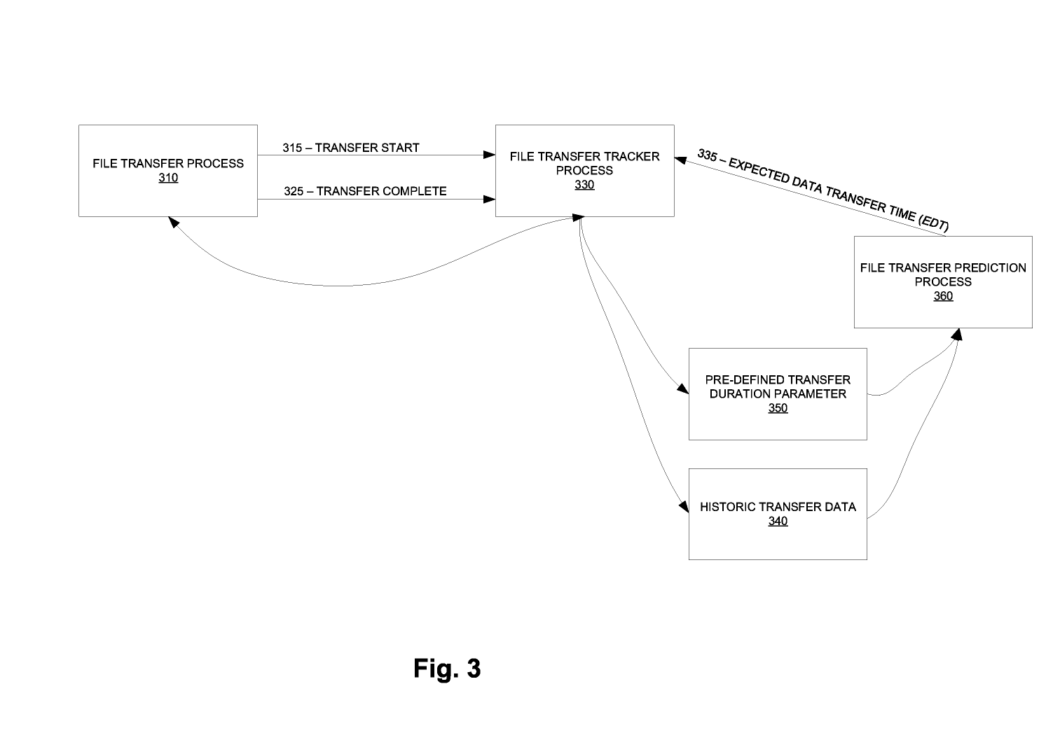

FIG. 3 illustrates an example of a process for tracking the transfer of files. As illustrated, a file transfer process 310 may initiate the transfer of a file, e.g., from transfer source 250 to transfer target 260, as illustrated in FIG. 2. As described above, file transfer process 310 may be implemented using an electronic file transfer protocol such as FTP, sFTP, HTTP, HTTPS, SMTP, or other electronic file transfer protocols as known in the art. Upon initiation of the file transfer process 310, a transfer start signal 315 may be sent to a file transfer tracker process 330, e.g., as implemented by monitor component 214 as illustrated in FIG. 2. As described above, the file transfer tracker process 330 may start a timer upon receiving transfer start signal 315 to track the duration of the file transfer as the ATT. The timer may then be stopped upon receiving a transfer complete signal 325 from the file transfer process 310.

File transfer tracker process 330 may also receive an EDT 335 from a file transfer prediction process 360. For example, file transfer prediction process 360 may be implemented on prediction engine 212, as described above with respect to FIG. 2. The EDT may be calculated as a function of data transfer parameters pᵢ from parameter database 216, as described above with respect to Equation 1. For example, data transfer parameters pᵢ may include pre-defined transfer duration parameters 350, e.g., as previously calculated by file transfer prediction process 360, programmed in non-transitory computer readable media on tracking server 210, or entered by a user through user interface component 218. In some examples, the pre-defined transfer duration parameter 350 is a threshold value to indicate the acceptable variance between ATT and EDT values before the file transfer tracker process 330 should trigger an alert condition. Data transfer parameters pᵢ may include historic transfer data 340, e.g., length of time for completion of one or more previous file transfers between transfer source 250 and transfer target 260; historical transfer rate(s) for previous file transfers (i.e., the file size divided by the length of time for the file transfer to complete); geographical locations of either or both of transfer source 250 and transfer target 260; time of day; date; historical transfer rate between transfer source 250 and transfer target 260 correlated with the time of day or date; size of the file being transferred; server capacity; server load; network capacity; network load; file type; file transfer protocol being used (i.e., FTP, sFTP, HTTP, HTTPS, SMTP, etc.); user defined parameters; or other parameters that may affect the rate at which data may transfer between transfer source 250 and transfer target 260 as known in the art.

File transfer tracker process 330 may then continuously or periodically monitor and compare the ATT and EDT values to determine if a the variance between the ATT and EDT exceeds a threshold value. In some examples, multiple threshold values may be defined, such that informational alerts are triggered and sent to user interface 218 or to a user device as the ATT approaches the EDT, and additional actions are initiated at other threshold levels as the ATT exceeds the EDT. For example, the alerts may terminate the file transfer process 310, restart the file transfer process 310, restart or load balance file transfer process 310 using an alternate network connectivity path or an alternate transfer source 250, or initiate other alert conditions as known in the art.

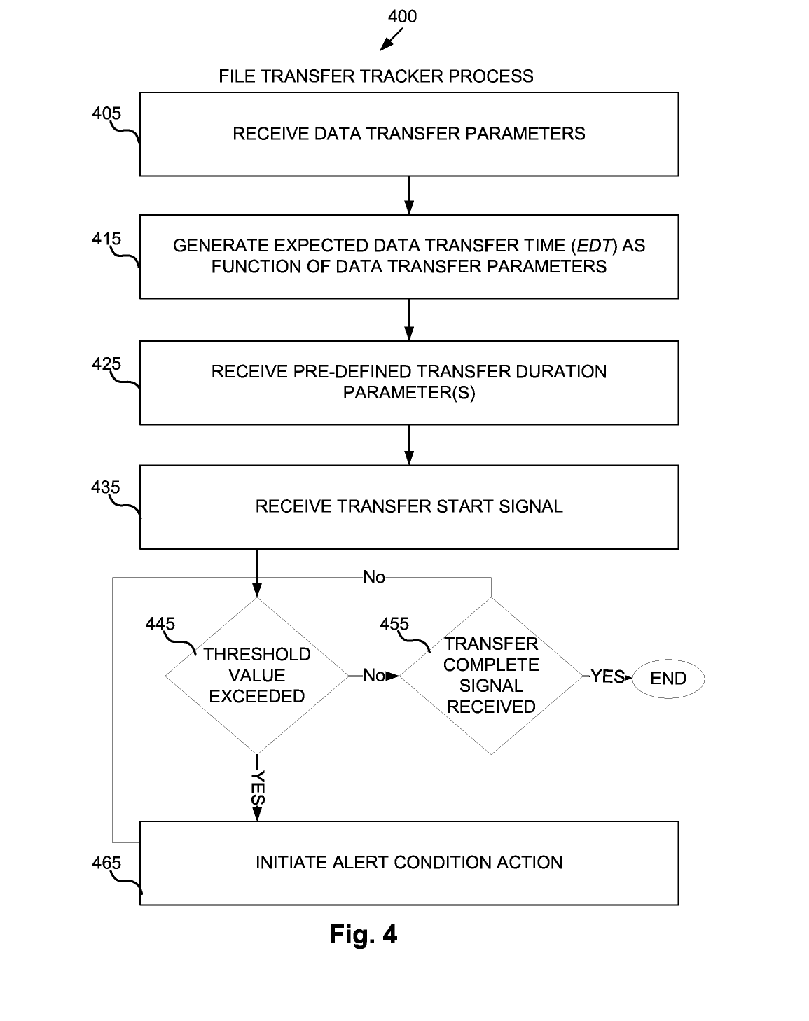

FIG. 4 is a flowchart illustrating an embodiment of a file transfer tracker process. Referring to FIG. 4, a file transfer tracker process 400 may include receiving data transfer parameters pᵢ at step 405 and generating an EDT as a function of the data transfer parameters pᵢ at step 415. For example, the data transfer parameters pᵢ may include the parameters as described above with respect to FIG. 2, and the EDT may be generated as described above with respect to Equation 1. The data transfer parameters pᵢ may further include parameters extracted from the data network, Internet, transfer target, transfer source, demographic databases, or other databases on the network consistent with data mining techniques known in the art. In some examples, the file transfer tracker process 400 may also include receiving pre-defined transfer duration parameter(s) at step 425. For example, the pre-defined transfer duration parameter(s) may include one or more threshold values defining threshold variances between the EDT and the ATT at which various alert conditions may be triggered. In some examples, a single alert condition may be triggered when ATT equals or exceeds EDT. In other examples, a single alert condition may be triggered when ATT approaches EDT, or exceeds EDT by a pre-defined threshold value indicated in a percentage of EDT or fixed time value. Multiple threshold values may be defined to indicate multiple corresponding alert conditions. Each alert condition may include the alert conditions described above with respect to FIGS. 2 and 3.

The file transfer tracker process 400 may also include receiving a transfer start signal at step 435. The file transfer tracker process may then track the time (ATT) from when the transfer start signal is received until either a threshold value is exceeded at step 445 or a transfer complete signal is received at step 455. If a threshold value is exceeded, then the file transfer tracker process 400 also includes initiating an alert condition action at step 465. For example, the alert condition actions may include the alert condition actions described above with respect to FIGS. 2 and 3. In some examples, the alert condition action terminates the file transfer, and the file transfer tracker process. In other examples, the alert condition action may trigger an alert message, or other action that allows the file transfer and file transfer tracker processes to continue running.

If no threshold value is exceeded at step 445, the file transfer tracker process may terminate if a transfer complete signal is received at step 455. Alternatively, the file transfer tracker process may continue to run if no transfer complete signal is received. In some embodiments, file transfer tracker process 400 runs continuously and continuously checks for the conditions indicated at steps 445 and 455. In other embodiments, the file transfer tracker process may periodically check for the conditions at steps 445 and 455.

The threshold value(s) may be configured to be less than, the same as, or more than the EDT. In one example, the threshold value is zero, such that the alert condition is triggered when the ATT exceeds the EDT. In another example, the threshold value is less than the EDT, such that an alert condition is triggered when the ATT approaches, but does not yet reach the EDT. For example, the threshold value may be −50% of the EDT, or may be set anywhere between −100% and 0% of the EDT. In other examples, the threshold value is greater than the EDT. For example, the threshold value may be the EDT plus 50%, or range anywhere from the EDT plus 0% to the EDT plus 100%, or more (i.e., double, triple, quadruple, etc. of the EDT). In some examples, the threshold value may include an additional fixed delay, such as 10 seconds, 20 seconds, a minute, many minutes, etc. past the EDT. In these examples, the alert condition would not be triggered until the threshold value delay has passed. In some embodiments, multiple threshold values may be set, wherein each threshold value corresponds to a separate alert condition. For example, a first threshold value may be reached and trigger a first alert condition (e.g., in the form of an alert message). Then, a second threshold value may be reached and trigger a second alert condition (e.g., in the form of another alert message, or an automated active response such as killing the file transfer, initiating load balancing or failover, etc.).

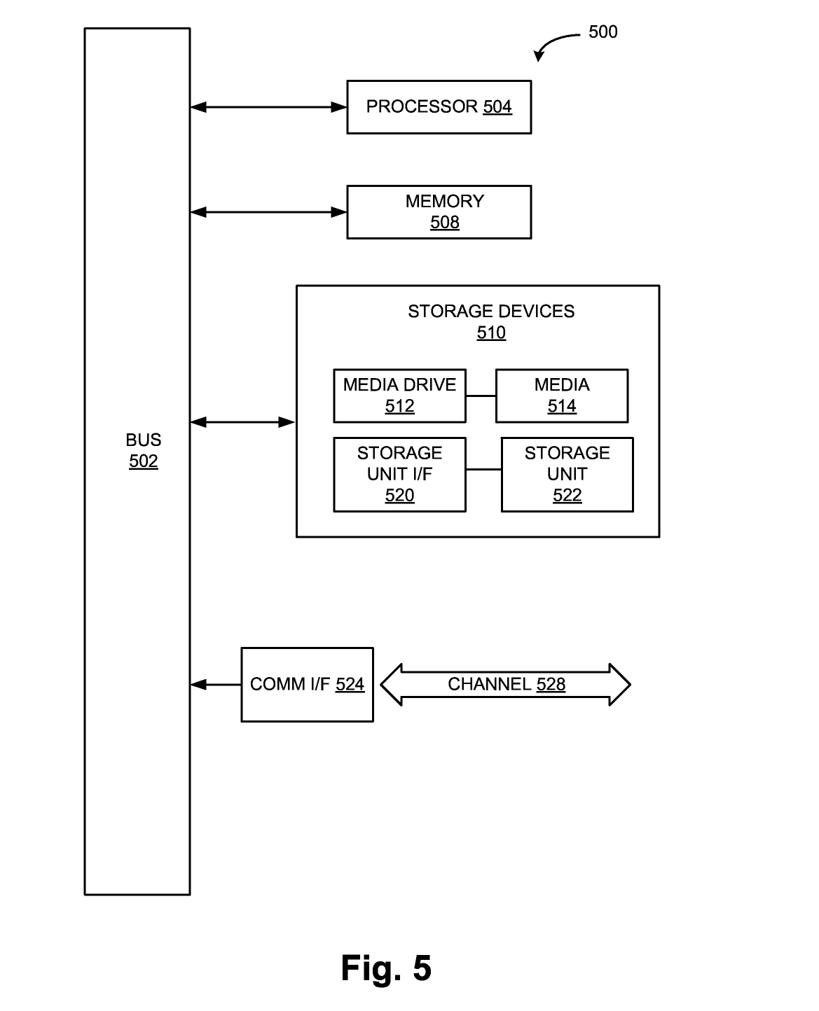

As used herein, the term component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. In implementation, the various components described herein might be implemented as discrete components or the functions and features described can be shared in part or in total among one or more components. In other words, as would be apparent to one of ordinary skill in the art after reading this description, the various features and functionality described herein may be implemented in any given application and can be implemented in one or more separate or shared components in various combinations and permutations. Even though various features or elements of functionality may be individually described or claimed as separate components, one of ordinary skill in the art will understand that these features and functionality can be shared among one or more common software and hardware elements, and such description shall not require or imply that separate hardware or software components are used to implement such features or functionality.

Where components of the application are implemented in whole or in part using software, in one embodiment, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

FIG. 5 illustrates an example computing component 500, an example of which may be a processor for executing the business ecosystem tool used to implement various features and/or functionality of the systems and methods disclosed in the present disclosure. Computing component 500 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, digital cameras, navigation systems, cellular telephones, portable computing devices, modems, routers, WAPs, terminals and other electronic devices that might include some form of processing capability.

Computing component 500 might include, for example, one or more processors, controllers, control components, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing component 500 or to communicate externally.

Computing component 500 might also include one or more memory components, simply referred to herein as main memory 508. For example, preferably random access memory (RAM) or other dynamic memory might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage devices 510, which might include, for example, a media drive 512 and a storage unit interface 520. The media drive 512 might include a drive or other mechanism to support fixed or removable storage media 514. For example, a hard disk drive, a floppy disk drive, a magnetic tape drive, an optical disk drive, a CD or DVD drive (R or RW), or other removable or fixed media drive might be provided. Accordingly, storage media 514 might include, for example, a hard disk, a floppy disk, magnetic tape, cartridge, optical disk, a CD or DVD, or other fixed or removable medium that is read by, written to or accessed by media drive 512. As these examples illustrate, the storage media 514 can include a computer usable storage medium having stored therein computer software or data.

In alternative embodiments, information storage devices 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot, a PCMCIA slot and card, and other fixed or removable storage units 522 and interfaces 520 that allow software and data to be transferred from the storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 524 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the components or functionality described or claimed as part of the component are all configured in a common package. Indeed, any or all of the various components of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A file transfer monitoring system for monitoring the transfer of an electronic file from a transfer source to a transfer target, the system comprising:
a tracking server and a data store;
the tracking server comprising a prediction engine, a parameter database, and a monitoring component;
wherein the prediction engine comprises a computer processor and a non-transitory computer-readable medium having a computer-executable program embedded thereon, the computer-executable program being configured to receive one or more data transfer parameters from a parameter database and generate an expected data transfer time (EDT) as a function of the one or more data transfer parameters; and
the monitoring component is configured to receive the EDT from the prediction engine, receive a transfer start signal from the transfer source, start a timer when the transfer start signal is received, and trigger an alert condition action if a transfer complete signal is not received before the timer exceeds a threshold value relative to the EDT.

2. The system of claim 1, wherein the one or more data transfer parameters comprise a size of the electronic file, a historical average transfer rate between the transfer target and the transfer source, a server capacity value, a server load value, a network capacity value, a network load value, a type of the electronic file, or a transfer protocol.

3. The system of claim 2, wherein the one or more data transfer parameters further comprises a set of historical transfer rates between the transfer target and the transfer source, wherein each historical transfer rate is correlated with a time of day.

4. The system of claim 2, wherein the one or more data transfer parameters further comprises a set of historical transfer rates between the transfer target and the transfer source, wherein each historical transfer rate is correlated with a geographical location of the transfer source.

5. The system of claim 1, further comprising a user interface, wherein the user interface is configured to receive a pre-defined transfer duration parameter from a user input device.

6. The system of claim 5, wherein the pre-defined transfer duration parameter is the threshold value.

7. The system of claim 1, wherein the alert condition action comprises the transmission of an alert message to a user device.

8. The system of claim 1, wherein the alert condition action comprises the transmission of a transfer termination signal to the transfer source.

9. A computer implemented method of tracking a file transfer process, the method comprising:
receiving, with a prediction engine, one or more data transfer parameters;
generating, with the prediction engine, an expected data transfer time (EDT) as a function of the data transfer parameters;
receiving, with a monitor component, the EDT and a transfer start signal;
initiating a timer; and
initiating an alert condition action if the timer exceeds a threshold value relative to the EDT.

10. The method of claim 9, wherein the one or more data transfer parameters comprise a size of the electronic file, a historical average transfer rate between the transfer target and the transfer source, a server capacity value, a server load value, a network capacity value, a network load value, a type of the electronic file, or a transfer protocol.

11. The method of claim 10, wherein the one or more data transfer parameters further comprises a set of historical transfer rates between the transfer target and the transfer source, wherein each historical transfer rate is correlated with a time of day.

12. The method of claim 10, wherein the one or more data transfer parameters further comprises a set of historical transfer rates between the transfer target and the transfer source, wherein each historical transfer rate is correlated with a geographical location of the transfer source.

13. The method of claim 9, further comprising receiving, with a user interface, a pre-defined transfer duration parameter.

14. The method of claim 13, wherein the pre-defined transfer duration parameter is the threshold value.

15. The method of claim 9, wherein the alert condition action comprises transmitting an alert message to a user device.

16. The method of claim 9, wherein the alert condition action comprises transmitting a transfer termination signal to the transfer source.

17. A computer implemented method of tracking a file transfer process, the method comprising:
receiving, with a prediction engine, one or more data transfer parameters;
generating, with the prediction engine, an expected data transfer time (EDT) as a function of the data transfer parameters;
receiving, with a monitor component, the EDT, a plurality of threshold values, and a transfer start signal;
initiating a timer; and
initiating a first alert condition action if the timer exceeds a first threshold value relative to the EDT.

18. The method of claim 17, further comprising initiating a second alert condition action if the timer exceeds a second threshold value relative to the EDT.

19. The method of claim 18, wherein the first alert condition comprises transmitting an alert message to a user device.

20. The method of claim 19, wherein the second alert condition comprises transmitting a transfer termination signal to the transfer source.
